(19) United States
(12) Patent Application Publication
(10) Pub. No.: US 2014/0187099 A1
(43) Pub. Date: Jul. 3, 2014

(54) HIGH-VOLTAGE RESISTANCE OF A CONNECTOR INTERFACE

(71) Applicant: CARDIOINSIGHT TECHNOLOGIES, INC, CLEVELAND, OH (US)

(72) Inventors: John T. Venaleck, Painesville, OH (US); Larry Crofoot, Perry, OH (US)

(73) Assignee: Cardioninsight Technologies, Inc., Cleverland, OH (US)

(21) Appl. No.: 14/115,596

(22) PCT Filed: May 3, 2012
(86) PCT No.: PCT/US12/36269

§ 371 Date: Feb. 14, 2014

Related U.S. Application Data
(60) Provisional application No. 61/481,854, filed on May 3, 2011.

(51) Int. Cl. H01R 13/04

(52) U.S. Cl. CPC H01R 13/04
USPC 439/660

(57) ABSTRACT

An electrical connector has dielectric posts surrounding the contacts and extending outwardly from the root along the contact axis a finite amount. The mating connector (or plug) has a housing that surrounds the posts. A device that includes both the electrical connector and the mating connector provides good electrical isolation between adjacent contacts.

### BACKGROUND

Electrical connector pairs typically have a plug and a receptacle. Electrical contacts within the plug and the receptacle are arranged laterally in close array. The lateral proximity of the contacts are typically too close to allow high voltage between them. It is desirable to provide a connector pair wherein high voltage between contacts will not cause current leakage or voltage breakdown.

### SUMMARY OF THE INVENTION

According to one aspect of the invention, both plug and receptacle connectors have rectangular dielectric posts surrounding the contacts and extending outwardly from a root.

According to another aspect of the invention, the plug has a housing with rectangular openings to accept the posts surrounding the contacts.

According to another aspect of the invention, the combination of dielectric posts and rectangular openings in the plug form isolation paths, preventing current leakage and voltage breakdowns when high voltage appears between the contacts.

According to a further aspect of the invention, a combination of a receptacle electrical connector and a plug that mates with the receptacle connector, may include one or more of the following features: the receptacle connector has connector contacts that have dielectric posts surrounding parts of the connector contacts; there are slots between the posts, separating the posts for the individual connector contacts; the plug has a housing with openings that accept the posts when the plug is mated to the connector; the openings are rectangular openings; the housing includes partitions that enter into the slots between the posts when the plug is mated to the connector; the combination of the posts and the partitions form isolation paths, preventing current leakage and voltage breakdowns when high voltage appears between the contacts; the posts are plastic posts; the plastic posts extend from a root that is a continuous molded piece with all of the posts; the posts are integral parts of a molded connector body of the connector; the plug has plug contacts that engage the connector contacts when the plug is mated with the connector; the plug contacts have dielectric posts surrounding parts of the plug contacts; the posts surrounding the plug contacts have slots between them; the posts surrounding the plug contacts are received in the rectangular openings; the partitions of the plug housing are located in the slots between the posts surrounding the plug contacts; and the posts surrounding the plug contacts are integral parts of a continuous unitary molded plastic piece that includes a header that is connected to all of the posts.

According to another aspect of the invention, a device includes: a receptacle electrical connector; and a plug that mates with the receptacle connector. The receptacle connector has connector contacts that have dielectric posts surrounding parts of the connector contacts

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various features of the invention.

FIG. 1 is an oblique view of a device in accordance with an embodiment of the present invention.

FIG. 2 is another oblique view of the device of FIG. 1.

FIG. 3 is a magnified view of part of a connector of the device of FIG. 1.

FIG. 4 is a magnified view of part of a plug of the device of FIG. 1.

FIG. 5 is an oblique view of part of the device of FIG. 1, with the insert portion of the plug omitted for clarity.

FIG. 6 is a plan view showing engagement of the contacts of the device of FIG. 1.

### DETAILED DESCRIPTION

An electrical connector has dielectric posts surrounding the contacts and extending outwardly from the root along the contact axis a finite amount. The mating connector (or plug) has a housing that surrounds the posts. A device that includes both the electrical connector and the mating connector provides good electrical isolation between adjacent contacts.

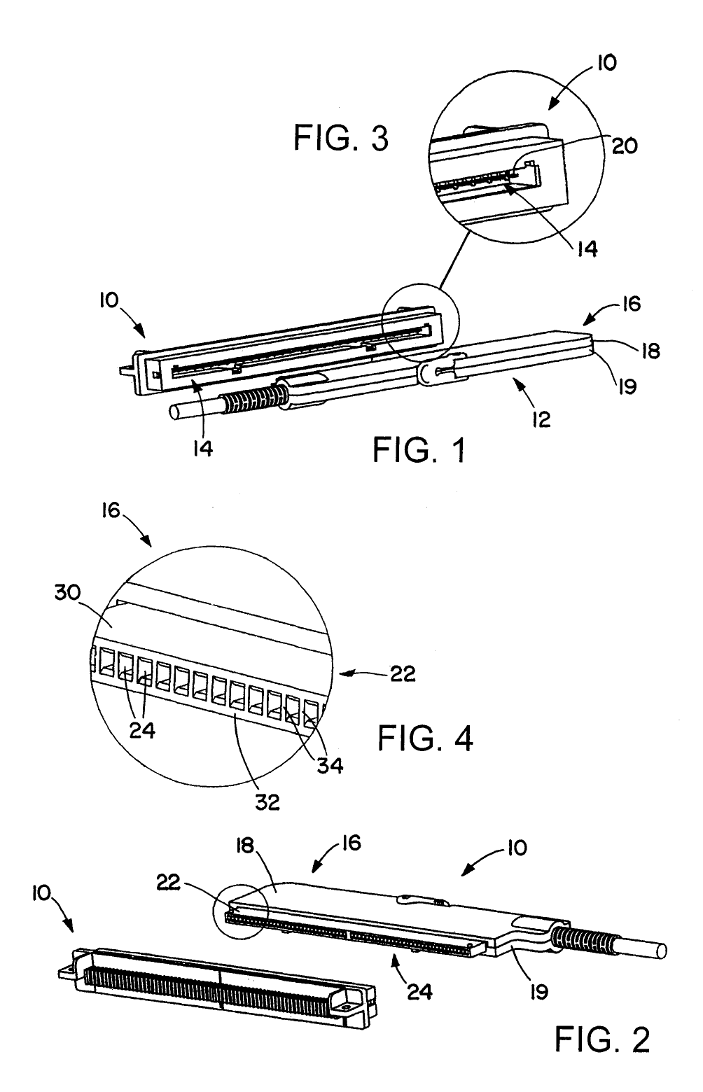

Referring initially to FIGS. 1 and 2, a device includes a connector or receptacle 10 that is engaged by a mating connector or plug 12. The connector 10 may be a circuit board edge connector configured to engage the edge of a circuit board (not shown). The plug 12 fits into an opening 14 of the connector 10 to engage the connector 10. The plug 12 has a housing 16, part of which is inserted into the opening 14 when the plug is engaged with (mated to) the connector 10. The housing 16 may include a pair of housing halves 18 and 19 that are joined together.

FIGS. 3 and 4 show some further details of the connector 10 and the plug 12. The connector 10 has receptacle contacts 20 within the opening 14. When an insert portion 22 of the plug housing 16 is inserted into the opening 14, the connector contacts 20 are engaged by plug contacts that are located within rectangular openings 24 in the plug insert portion 22. Each of the plug contacts is in a respective rectangular opening 24. The plug contacts within the rectangular openings 24 are surrounded by dielectric material of the plug insert portion 22. All of the rectangular openings 24 share a common top wall 30 and a common bottom wall 32. A series of partitions 34 run from the top wall 30 to the bottom wall 32 to separate the space between the walls 30 and 32 into the individual rectangular openings 24. The partitions 34 and the walls 30 and 32 may all be parts of a single molded plastic piece that defines the rectangular openings 24. The plastic piece is part of the plug housing 16.

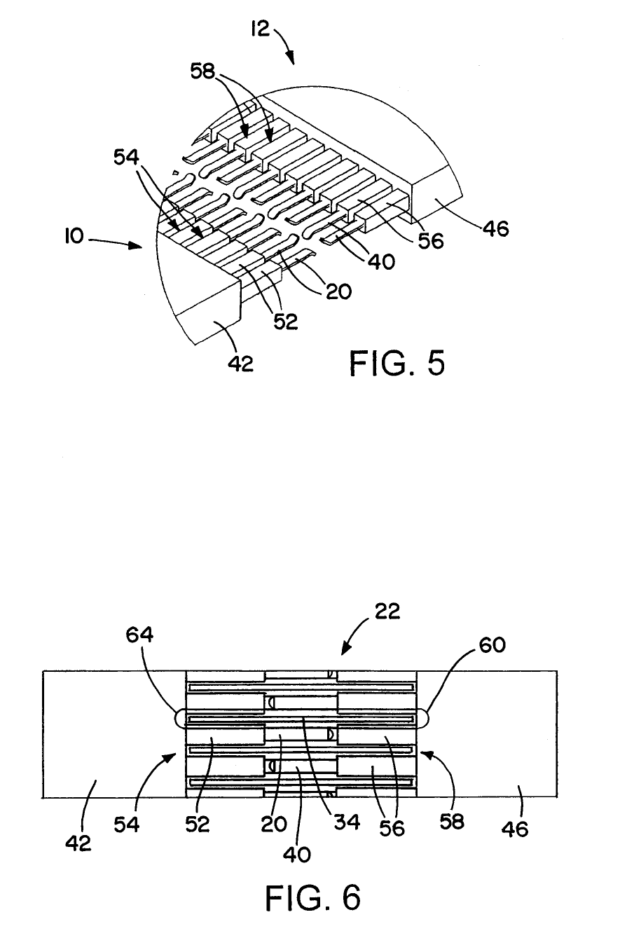

Turning now to FIG. 5, the connector contacts 20 are shown just out of engagement with plug contacts 40. The contacts 20 and 40 are illustrated as hermaphroditic contacts, but alternatively may be other types of contacts. The spacing between the connector (receptacle) contacts 20 may be about 0.020 inches, and the plug contacts 40 have the same spacing. The connector contacts 20 are attached to a plastic connector root 42, which may be a part of a connector body of the connector 10 (FIG. 1). The plug contacts 40 are attached to a plastic plug header or root 46, which may be inserted into the plug 12 (FIG. 1) such that the plug contacts 40 extend into the rectangular openings 24 (FIG. 4) of the plug 12.

Plastic posts 52 surround the connector contacts 20 near the connector root 42, where the connector contacts 20 emerge from the connector root 42. The posts 52 extend along contact axes of their respective connector contacts 20. Slots 54 are located between adjacent of the posts 52 (and therefore also adjacent of the connector contacts 20 in the vicinity of the posts 52). Plastic posts 56 similarly surround the plug contacts 40 where the plug contacts 40 emerge from the plug header or root 46. Slots 58 are located between adjacent of the posts 56 (and therefore also adjacent of the plug contacts 40 in the vicinity of the posts 56).

With reference now to FIG. 6, the plug contacts 40 are shown as inserted into the plug insert portion 22, such as occurs when the plug 12 is assembled. The plug contacts 40 are separated from one another by the partitions 34. The posts 56 also extend into the plug insert portion 22, with the partitions 34 in the slots 58 between the posts 56. The combination of the partitions 34 and the posts 56 electrically isolate the plug contacts 40 from one another. Instead of the gap to be bridged between adjacent plug contacts 40 being the separation distance between the contacts 40, a signal would have to bridge the isolation path 60, which runs past the posts 56 and around the end of the partition 34.

A similar extended isolation path 64 is provided for the connector contacts 20. When the plug 12 is inserted into the connector 10 the ends of the partitions 34 engage the slots 54 between the posts 52. The partitions 34 and the posts 52 combine to increase the isolation path 64 between the connector contacts 20 significantly beyond the spacing of the connector contacts 20. The extended isolation paths 60 and 64 aid in preventing current leakage and voltage breakdowns when high voltage appears between the contacts 20 and 40.

As an alternative all or part of the plug header 46 and/or the posts 56 may be formed as an integral molded part with other portions of the housing of the plug 12.

Many variants are possible regarding the above device and method. For example device may include any suitable number of contacts, as well as various configurations for the contacts.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A device comprising:
a receptacle electrical connector; and
a plug that mates with the receptacle connector;
wherein the receptacle connector has connector contacts that have dielectric posts surrounding parts of the connector contacts.

2. The device of claim 1, wherein there are slots between the posts, separating the posts for the individual connector contacts.

3. The device of claim 1, wherein the plug has a housing with openings that accept the posts when the plug is mated to the connector.

4. The device of claim 3, wherein the openings are rectangular openings.

5. The device of claim 3, wherein the housing includes partitions that enter into the slots between the posts when the plug is mated to the connector.

6. The device of claim 5, wherein the combination of the posts and the partitions form isolation paths, preventing current leakage and voltage breakdowns when high voltage appears between the contacts.

7. The device of claim 1, wherein the posts are plastic posts.

8. The device of claim 7, wherein the plastic posts extend from a root that is a continuous molded piece with all of the posts.

9. The device of claim 7, wherein the posts are integral parts of a molded connector body of the connector.

10. The device of claim 1, wherein the plug has plug contacts that engage the connector contacts when the plug is mated with the connector.

11. The device of claim 10, wherein the plug contacts have dielectric posts surrounding parts of the plug contacts.

12. The device of claim 11, wherein the posts surrounding the plug contacts have slots between adjacent posts.

13. The device of claim 11,
wherein the plug has a housing with openings that accept the posts when the plug is mated to the connector;
wherein the openings are rectangular openings the posts surrounding the plug contacts are received in the rectangular openings; and
wherein the partitions of the plug housing are located in the slots between the posts surrounding the plug contacts.

14. The device of claim 11, wherein the posts surrounding the plug contacts are integral parts of a continuous unitary molded plastic piece that includes a header that is connected to all of the posts.

15. The device of claim 1,
wherein there are slots between the posts, separating the posts for the individual connector contacts;
wherein the plug has a housing with openings that accept the posts when the plug is mated to the connector;
wherein the openings are rectangular openings;
wherein the housing includes partitions that enter into the slots between the posts when the plug is mated to the connector;
wherein the plug has plug contacts that engage the connector contacts when the plug is mated with the connector;
wherein the plug contacts have dielectric posts surrounding parts of the plug contacts; and
wherein the posts surrounding the plug contacts have slots between adjacent posts.
